(19) United States
(12) Patent Application Publication
(10) Pub. No.: US 2008/0292080 A1
(43) Pub. Date: Nov. 27, 2008

(54) SYSTEM AND METHOD FOR ADDING AND ASSOCIATING USERS ON CONTACT ADDRESSBOOK

(76) Inventors: COLIN SHONG CHIN QUON, VANCOUVER (CA); CHRISTOPHER ALAN RICHARDSON, Surrey (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/752,162

(22) Filed: May 22, 2007

(51) Int. Cl. H04M 3/42

(52) U.S. Cl. 379/201.02

(57) ABSTRACT

Systems and methods are disclosed that allow a service user to add other service users and non-users into the service user's address book based on contact telephone numbers. This method allows a first service user to be associated either automatically or through an invitation process with a second service user via their telephone numbers for them to be service contacts on each other's service phonebook. Systems and methods for growing a service user base are also provided.

### BACKGROUND

1. Technical Field

The present disclosure relates generally to communications services and specifically to contact management methods and systems.

2. Description of the Related Art

Online communities, such as Myspace.com and Facebook.com, utilize email addresses generally obtained from their current users to invite new potential users to virally grow the user base. Non-users that accept the invitation become new users of the online community, and the invitee becomes a “friend” of, or otherwise associated with, the inviter user. Social networks, such as LinkedIn and Friendster, also follow the concept of using a user's social network of contacts to accelerate user growth. The invitees who join and accept the invitations become part of the inviter user's personal network or circle of friends. Contact address book enhancement applications, such as Plaxo, also have means to leverage a user's existing contact list to invite new potential users to join the service. However, the invitation method for these online communities and social networks is typically limited to online identities, such as email addresses. For contact address book extensions such as Plaxo, the address book is mostly a means to keep contact information up-to-date rather than as a means to grow the number of contacts in the address book.

Mobile VoIP services such as Mig33, Jajah, Truphone, Fring, and Nimbuzz also have methods to invite users to join the respective services using contact email address and phone numbers. Generally, services such as Mig33 and Jajah are asymmetric services where the value proposition is primarily for the caller to call the callee without requiring any involvement from the callee party. Others, such as Truphone and Fring, have more direct reasons to invite the callee party to become users of the same service community as symmetric services, similar to Skype, can reduce the cost for both the caller and the callee. However, all these services rely in email addresses and online identities to invite and associate users on the online service contact list.

### SUMMARY

An embodiment of the present disclosure may be found in EQO Mobile, a mobile phone service from EQO, the assignee of the present disclosure, that enables users to make global calls at some of the lowest international rates available, send global text messages, and chat using all the major Instant Messaging clients such as MSN Messenger, GoogleTalk, Yahoo, AIM, and ICQ. EQO provides a free downloadable mobile software application that is easy to install, and as simple to use as a standard phone address book. The EQO-to-EQO voice calling service allows voice calls between any EQO users as local dial access calls or free VoIP calls. The EQO Out voice calling service allows EQO users to call any phone number from mass market mobile phones. The EQO service also supports EQO-to-EQO multimedia messaging, EQO Out text messaging, and premium services such as click-to-conference, dynamic call disposition such as redirect to alternate number or voice mail, directory services etc. The EQO service as generally described herein is an example of a system that embodies the present disclosure.

In one embodiment of the present disclosure, a system allows a service's user to import contacts from the user's pre-existing mobile phone book and send invitations to the contacts based on the contact telephone numbers to join and become members of the service. This inventive element leverages the user's existing contact list on the mobile phone, and uses the contact list telephone numbers to build an address book that the user can use to initiate various communications with other users in the same service community as well as users outside of the service community. This inventive design allows the user to add and invite contacts from multiple interface points in the service such as during ad-hoc calling to any mobile telephone number.

Another aspect of an embodiment of the disclosed system's design is the method of associating contacts and users in the service community. In one embodiment, as an example, “John” signs up for the service and has “David's” phone number on his contact list, and if David is also a user of the same service community and has John's phone number on his contact list, these two users are automatically associated as contacts on each other's contact service contact address book. This preferably allows “John” and “David” to symmetrically initiate voice, multimedia messaging, and instant messaging sessions while they are both online and also asymmetrically initiate voice and multimedia messaging if one of them is offline. This inventive design allows any mobile user who becomes a member of the service community to quickly assimilate all contacts in the user's existing phone address book into a service phonebook. This method of adding and associating can be combined with invitation and contact association via email address, service ID, and online community identity to further broaden the service user's potential base of contacts in a service address book.

An aspect of the present disclosure includes a method of adding and associating users of a service based on user contact number. Such a method includes accepting, via an application client, a set of contact information associated with an individual for storage in a user's service phonebook, the contact information including a name of the individual and a method of contacting the individual; comparing the set of contact information associated with an individual with information related to a second service user; and when at least a portion of the set of contact information matches the information related to the second service user, sending a service association request to the second service user.

Another aspect of the present disclosure provides a computerized method of associating service users. It may include storing first and second service phonebooks associated with respective first and second service users, wherein each service phonebook including one or more contact entries. In an embodiment, the method includes searching the first service phonebook's contact entries for a contact entry associated with the second service user, and, if the first service phonebook includes the contact entry associated with the second service user, searching the second service phonebook's contact entries for a contact entry associated with the first service user. If both the first service phonebook includes the contact entry associated with the second service user and the second service phonebook includes the contact entry associated with the first service user, the contact entry associated with one or both of the service users is updated to indicate a service association with the other service user.

Another aspect of the present disclosure includes a method of associating users of a communications service, wherein a service phonebook for a first service user is maintained in computer storage. In an embodiment, upon adding contact information associated with a second service user to the service phonebook, the contact information associated with the second service user and information associated with the first service user are used to generate an invitation to add the first service user to a service phonebook associated with the second service user. The invitation is then sent to a service device operated by the second service user.

Another aspect of the present disclosure provides a method of updating a phonebook for a communications service that maintains, in computer storage, a first service phonebook associated with a first service user, the first service phonebook including contact information associated with a second service user. In an embodiment, an update to the contact information associated with the second service user is accepted from the second service user, and checking is performed to determine whether an association indication exists between the first service user and the second service user. If there is an association between the first and second user, the first service phonebook is altered with the update to the contact information.

Other aspects of this disclosure describe computer systems that implement the methods described.

Neither this summary nor the following detailed description purports to define the invention. The invention is defined only by the claims.

### BRIEF DESCRIPTION OF THE DRAWINGS

FIG. 1 illustrates an embodiment of a service system such as may utilize the disclosure herein.

FIG. 2 illustrates an embodiment of a method for adding and inviting another service user from the service mobile client ad hoc telephone dialer.

FIG. 3 illustrates an embodiment of a method for inviting a single contact or inviting multiple contacts to join the system's service utilizing a service phonebook.

FIG. 4 illustrates an embodiment of a method for inviting a contact to join a service from a service mobile client add contact client interface.

FIG. 5 illustrates an embodiment of a method for inviting a contact to join a service from an IM contact list on a service mobile client.

FIG. 6 illustrates an embodiment of a use case flow of adding, inviting, and associating another service or non-user.

FIG. 7 illustrates an embodiment of the use case flow of a service user inviting and associating another user of the same service in their respective service phonebooks.

FIG. 8 illustrates an embodiment of method of inviting other users to join a service via alternate methods, such as email address and IM contact ID.

### DETAILED DESCRIPTION OF SPECIFIC EMBODIMENTS

The following description is intended to illustrate specific embodiments and features of the disclosure, and is not intended to limit the scope of the invention.

A communication service will now be described that embodies various inventive features. Users who are registered with the service will be referred to as “service users” and others as “non-users.” The user application client of the service on a mobile device may be referred to as a “mobile client” or an “application client.” The terms “address book” and “phonebook” are used interchangeably herein and are meant to be given a broad interpretation. A phonebook or address book described herein includes any listing of contact information and may include entries for contacts' names, addresses, phone numbers, email addresses, instant messaging service screen names, other service screen names or IDs, and the like. The disclosure herein may be well suited to use in conjunction with services such as the communications services described in U.S. Provisional Patent Application No. 60/814,150, titled “Online Community and Identity Extension to Mobile Devices,” filed Jun. 16, 2006, the entire disclosure of which is hereby incorporated by reference. It is understood, however, that this disclosure may be implemented with relation to any of a number of various services or may be a standalone service.

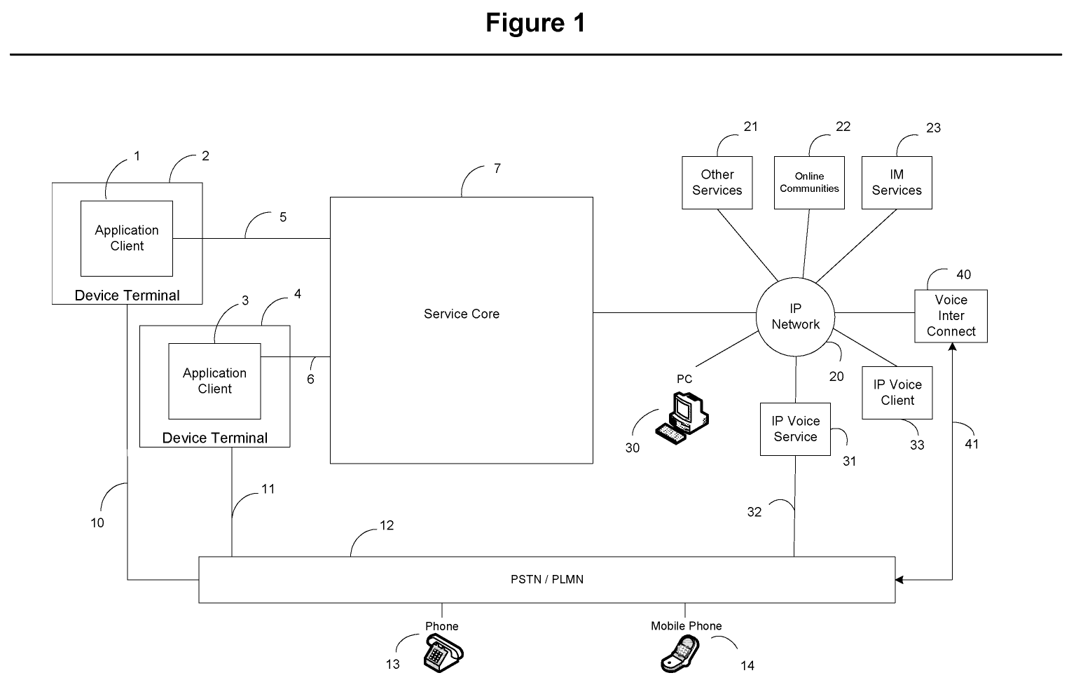

An embodiment of a system providing call routing services and utilizing the disclosure herein is illustrated in FIG. 1. As shown in FIG. 1, the system preferably comprises multiple application clients 1, 3 hosted on any of a variety of respective device terminals 2, 4. In an embodiment, the device terminals are preferably mobile devices having an open application environment such as J2ME, Blackberry, Symbian, or WindowsMobile. The device terminals 2, 4 preferably are capable of accessing voice service network 12 through respective network interfaces 10, 11 and for signaling between application clients 1, 3 with service core 7 through respective data network interfaces 5, 6. Media layer network interfaces 10, 11 and signaling layer network interfaces 5, 6 may be provided by converged voice and data service networks including GSM/GPRS/EDGE, UMTS, CDMA, WiFi, and WiMAX. In a preferred embodiment, the application clients 1, 3 are the same as, or similar to, the mobile client described in application Ser. No. 11/428,283, filed on Jun. 30, 2006, the disclosure of which is hereby incorporated by reference. It is understood that application clients 1, 3 may be implemented in various other ways, however.

The application clients 1, 3 preferably comprise a signaling interface to the service core 7 via their respective network interfaces 5, 6 that are preferably, but not necessarily, IP transport network interfaces. The application clients 1, 3 may comprise a media interface such as support for voice services via the respective device terminals 2, 4 through the respective service network interfaces 10, 11. In another embodiment, the application clients 1, 3 and an instance of the VoIP media client 33 can be on the same respective device terminals 2, 4. The application clients 1, 3 preferably provide user interfaces to content such as a contact list, message list, instant messaging, and/or events such as call requests, presence status indicators, messaging, and contact synchronization based on digital signals received over the respective interfaces 5, 6. The application clients 1, 3 also preferably transmit client and user event information over the respective interfaces 5, 6 to the service core 7. The application clients 1, 3 hosted on their respective device terminals 2, 4 may also have access to the voice and data services on the device terminals 2, 4 through their respective internal device application programming interfaces (API).

In an embodiment, the service core 7 includes service gateway functionality for bridging core services extended to the application clients 1, 3. The service gateway in the service core 7 is preferably an extension of the service gateway described in application Ser. No. 11/428,283 referenced above. The service gateway in the service core 7 may also provide other service bridging functions such as interfaces to IM services networks 23, such as MSN, Yahoo, AIM, or QQ, online communities 22, such as Myspace or Facebook, and other services 21, such as Skype or Short Messaging Service (SMS) interconnect. The service core 7 may also include other service provider infrastructure functions such as a subscriber service database, contact list and presence server, accounting and billing mediation, prepaid servers, service payment web services, registrar and redirect servers, web servers for service fulfillment and/or user provisioning, and network management as well as other operational and business support systems.

For voice service, in an embodiment, the service core 7 interfaces with a voice service network 12, such as the public switched telephone network (PSTN), and an IP voice service network 31 through the IP network 20 or voice interconnect provider network 40. With this service, a user with application client 1 on user terminal 2 can establish communications sessions with a user with application client 3 on user terminal 4 directly through respective interfaces 10,11 via network 12, or can be bridged through the service core 7 via the IP voice services 31 or voice interconnect service 40. In an embodiment, users with application clients 1, 3 on respective user terminals 2, 4 may also establish communications with land-based telephone 13, mobile phone 14, or an IP end point, such as a computer 30 or IP voice client 33 through network 12 or through the service core 7 via call origination and termination interconnect services available through voice interconnect service 40 or IP voice service 31.

In an embodiment of the system, a user may utilize a computer 30 to sign up for the service and download the application client 1 to the user's device terminal 2. The device terminal 1 may be any of a number of communications devices, but is preferably a mobile phone. Upon first sign in, the application client 1 may attempt to import all contacts from an address book native to the device terminal 2 into an application client 1 service phonebook. In various embodiments, the service phonebook may have various features, but preferably it contains at least contact names and associated contact information, such as mobile or land-based phone numbers, instant messaging screen names, email addresses, and the like. The phonebook also preferably communicates with the service gateway 7 to update information about each contact, such as whether the contact is also a service user, the availability of another service user, preferred modes of communication for the other service user and the like. For example, a service user's service phonebook may contain entries for contacts A, B, C, and D. Contacts A and B may have associated mobile phone numbers, whereas contact C has a telephone number, a VoIP account, and an instant messaging screen name. Contact D may only have an instant messaging screen name. Contact B and C may also be users of the service. At any given time, in an embodiment, the user may see that contact B is signed on to the service and available; contact C may be available only through the VoIP account; and contact D is signed on to his IM service.

Service users with suitable device terminals 2 that succeed in importing their contacts will preferably be presented with their contact list in the service phonebook. Alternatively, in an embodiment, a user may be prompted to add a contact into the service phonebook manually. Contacts added or imported to the service phonebook that are already users of the service themselves may automatically appear as service users in the user's phonebook. An application client 1 may communicate with service core 7 to determine which contacts are also service users, such as by a comparison of mobile number or service ID.

In one embodiment, after the service user has made a call, the application client 1 can prompt the user to invite one or more of the called non-user contacts to join the service. Also, the service user may decide to invite non-user contacts manually. In such a case, the service user may be presented with a list of the service user's non-user contacts with mobile numbers to invite. A service invitation message may preferably be delivered to the invitee as an SMS message, and, if so, the service can spoof the originating mobile number of the SMS message that originates from the service to be that of the mobile MSISDN of the user's device terminal 2. If the invitee is already a service user and the invitee has the inviter in his or her service phonebook, the invitee and inviter may both see each other as service contacts. If the invitee is a service user but does not have the inviter in his or her service phonebook, the inviter can see the invitee as a service user, and in one embodiment, the service sends the invitee a service system message asking the invitee to add the inviter to the invitee's service phonebook.

In an embodiment, invitees that are not service users may receive an SMS invite message from the service that may be spoofed with originating caller ID of the mobile MSISDN of the inviter such that the invitees may recognize the user trying to invite them. This invitation message may contain a link to a web page where an invitee can sign up and download an application client 1, 3 to his or her own phone. During this service signup flow for the invitee, the service can determine the invitee's country based on the invitee mobile number as specified by the inviter. In an embodiment, the service can automatically detect the invitee's mobile phone model, phone make, and preferred language based on the invitee's mobile browser user agent string. From the mobile browser, the invitee can signup for the service (which may include steps such as creating a Service ID and password, specifying an email address, and the like) and then download the appropriate application client 1, 3 to the invitee terminal device 2, 4, such as their phone. After the invitee installs the application client 1, 3 and sign-on to the service, the invitee and inviter may be automatically associated and appear on each other's Service phonebook. The service core 7 may keep record of these invitations and sign-ups and push updates to appropriate application clients 1, 3, such as based on those who created and sent the invitations.

In one embodiment, if a user has invited one or more non-user contacts to join the service, the service core 7 may inform the service user via service system message of invitees that accepted, the status of outstanding invitations, and other information, such as failed invitation deliveries. If the invitee is not in a supported country, the service may queue the invitation and inform the service user (inviter) that the invitation may be sent to the invitees when the service is supported in such countries.

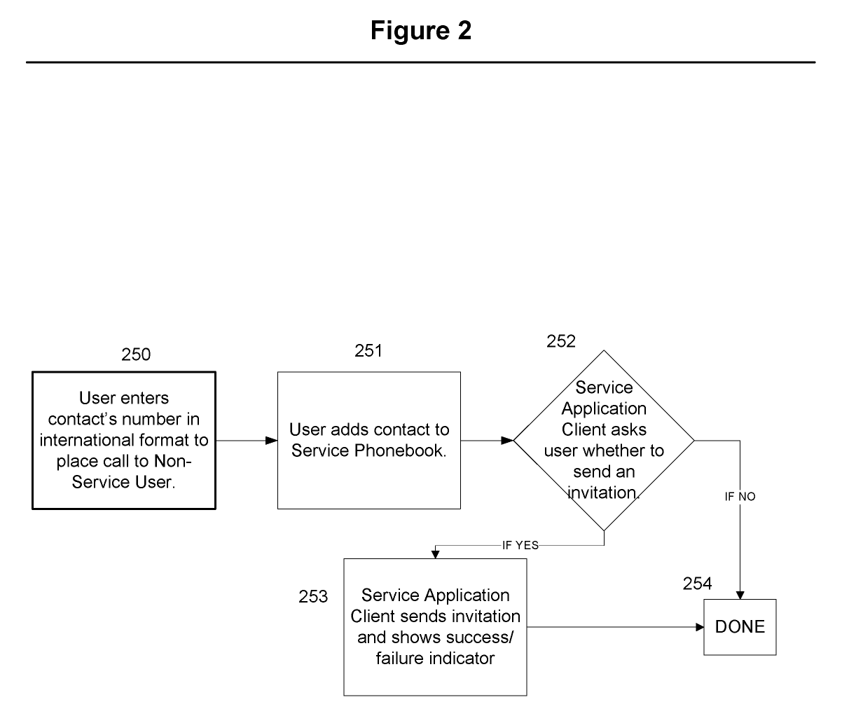

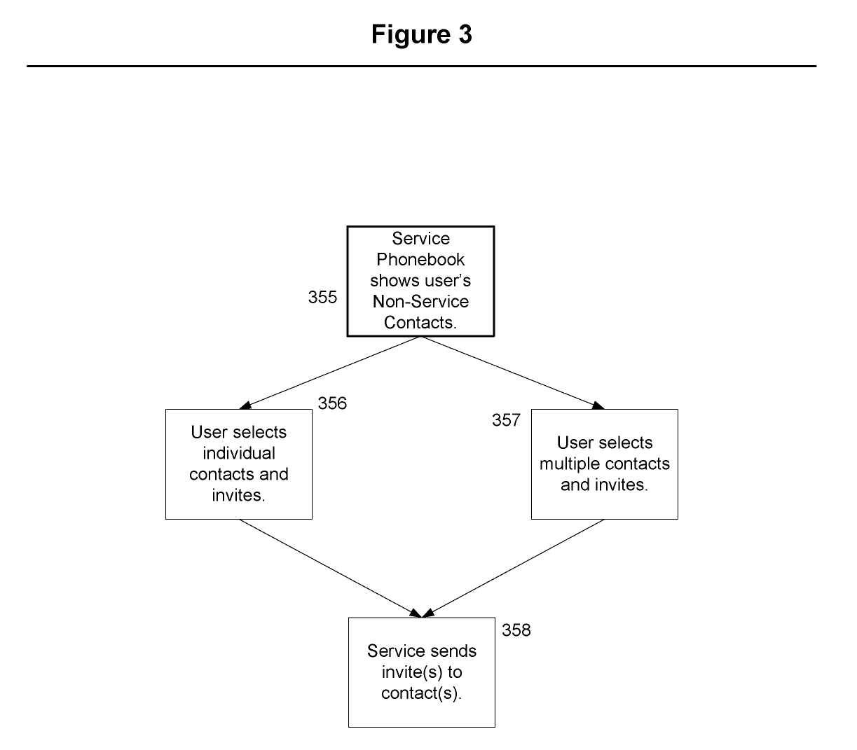

FIG. 2 shows an example of one embodiment of adding and inviting another user from an application client 1, 3 ad-hoc telephone dialer. For example, a user may enter a contact number to place a call to a non-user (block 250). Either before or after the call, the application client may prompt the user to add the contact number to the application client's 1, 3 service phonebook (block 251). In block 252, the service user may be prompted as to whether an invitation should be sent to the new contact. If the user indicates an invitation should be sent, the application client 1, 3 communicates the required information to the service gateway 7 and optionally indicates whether the invitation was successfully sent (block 253); otherwise, the process is completed (block 254). An application client preferably provides a user interface through which a service user can add contacts to the service phonebook, as well as invite contacts and place calls based on dialed numbers. FIG. 3 depicts one embodiment of a method of inviting a single contact or multiple contacts to join the service from the service phonebook. In this particular flow, after the service user makes a certain number of calls to the same callee number, the application client 1, 3 may prompt the user to optionally send an invitation to the called number (block 355). Also, the Service user can select one or more non-user contacts from the service user's existing contact list in the device terminal's 2, 4 address book and invite them to become service users (blocks 355, 356). The application client 1, 3 may then communicate with the service gateway 7 and provide the phone numbers associated with the service user selected contacts for generation and delivery of invitations (block 358).

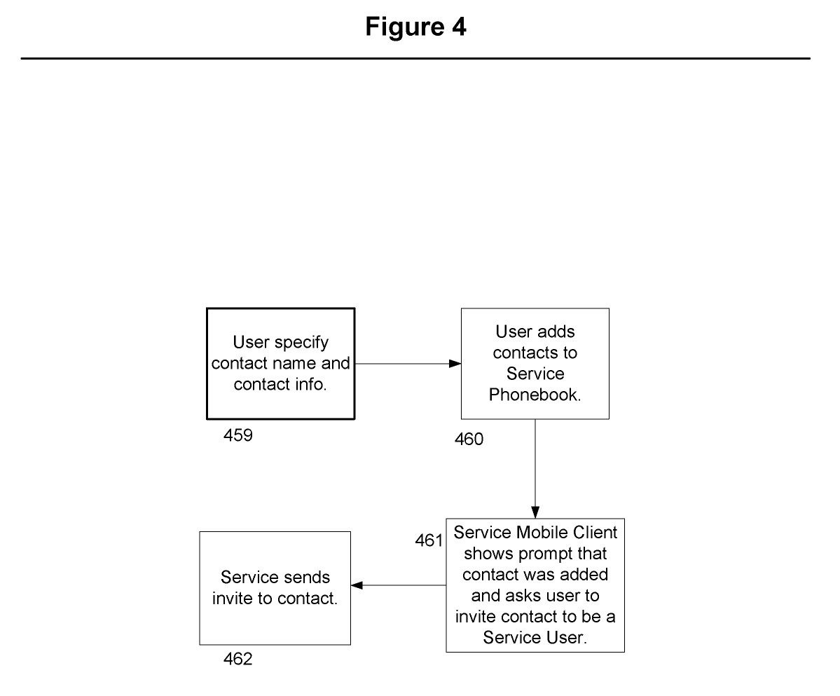

FIG. 4 shows an embodiment of a service user inviting a contact to join the service during the add contact process. The user enters contact name and information for storage in the service phonebook (blocks 459, 460). Upon completion, the application client 1, 3 may store the new phonebook entry and prompt the user to send a service invitation to the new contact (block 461). Similar to step 358 above, the application client 1, 3 may then communicate with service gateway 7 to get the invitation delivered if the user chooses to do so (block 462). Effectively, any step of adding or calling a contact on the address book may provide a means for the service user to invite the contact to become a member of the service.

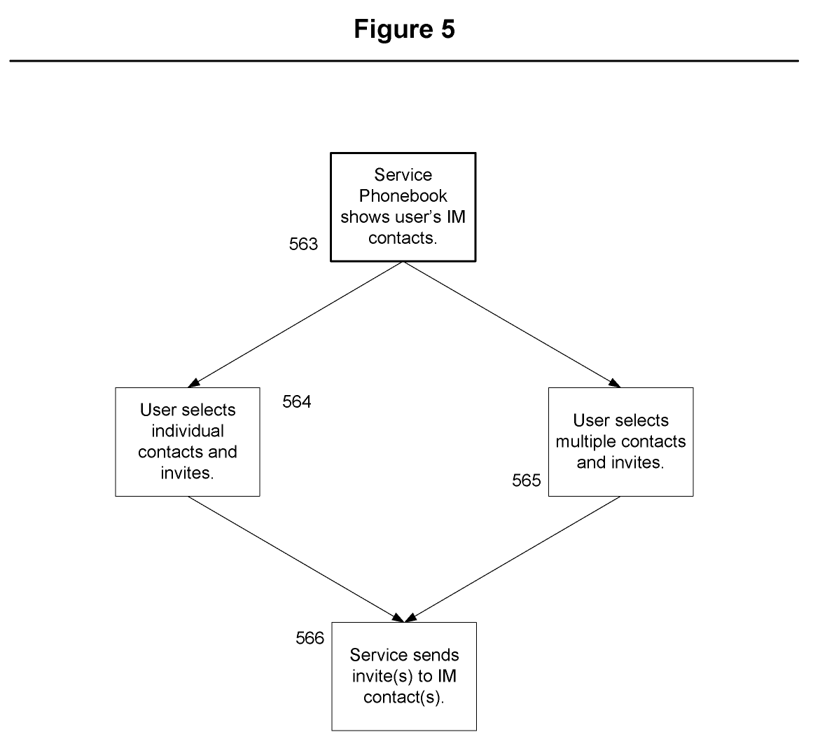

In some embodiments, the service also manages instant messaging features, either through its own system or through connections to third party systems, such as AOL, Yahoo!, ICQ, and the like. FIG. 5 shows such an embodiment and a method of inviting one or multiple instant messaging contacts to become members of the service from an instant messaging user interface provided by the application client 1, 3. The invitation process can be automatically triggered based on service usage, such as after a specified number of IM session is closed, the service user is then prompted to invite IM contacts on IM service networks such as MSN, Google Talk, and Jabber to become members of the service (block 563). The application client may show all invitable IM contacts, and allow the service user to select and invite one or more of the IM contacts to become members of the Service (either block 564 or 565). After the invitations are sent (at block 566), the invited IM contacts may receive an instant message with a link from the Service with instructions to signup as members the Service. The invitations, as with any other invitations discussed, may also take the form of emails, text messages, or the like, depending on the information available to the application client 1, 3 through the service phonebook or the terminal device's address book. In an embodiment, once an invited user signs up for the service, the invitee and inviter are automatically associated within the service and be added as contacts to each other's service phonebooks.

In various embodiments, the system may include features that implement one or more of the following business logic rules that may be applied in associating inviter and invitee users in the service.
1. If service user B is added based on user B mobile number by service user A, service user B is added to service user A's service phonebook, and service user A will see the presence of service user B, and service user A can initiate communications with service user B via the service. The service then sends service user B a request to add service user A into service user B's service phonebook.
2. A service user A can not call another service user B unless that service user A has service user B's telephone number or service user B has granted service user A permission (via invite) to call service user B.
3. Service users can be automatically linked as service contacts when they have each other's mobile numbers on their contact lists already.
4. When service user A adds or imports a mobile number belonging to service user B, the service can automatically send an add request to service user B to add service user A to service user B's service phonebook.
5. When service user A adds or imports a mobile number that is not associated with an existing service user, the service will ask service user A to invite the contact to become members of the service.
6. When service user A invites service user B via email (for example, where user A may not know the mobile number of user B), an add request can not be sent to the service user B if the email address of service user B has been verified to be owned and associated with service user B. If the email address of service user B has not been verified, the invitation can still be sent to the email address as specified by service user A.
7. Email invite message can be used to initiate a web session for invitee to sign up for the service or sign in to accept the service relationship between the inviter and invitee.
8. Adding another service user contact via service ID or verified email address associated with the service can behave as a typical invite process—invitee service user does not show up in the inviter service user service phonebook until the invitee service user accepts the invitation request.
9. Deleting service user A by service user B on service user B's service phonebook does not affect service user B being on service user A's service phonebook.
10. If service user A unsubscribe from the service, then all service users with service user A on their service phonebook will see service user A as a non-user contact.

A Service user can add another Service user on the Service phonebook contact list via a number of means including the contact's Service ID, email address, or mobile phone number.

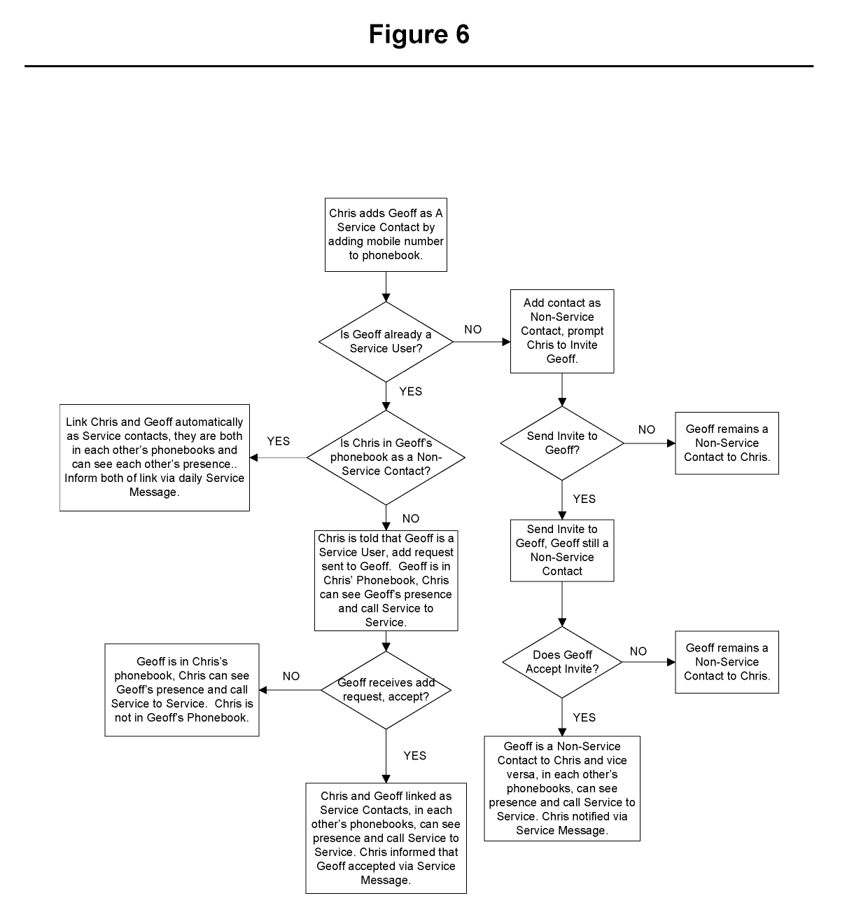

FIGS. 6-8 provide sample flow diagrams for specific user invite cases. It would be understood by one of skill in the art that any of a number of other invitation rules may be implemented by various embodiments of the service system. FIG. 6 is an embodiment of a sample use case flow showing a Service user “Chris” adding a contact “Geoff” and applying the business rule logic as listed above. The sample use case flow depicts the processing logic applied conditional on “Geoff” being a non-user or an existing service user, and the invite and accept decision paths. In the portion of the use case flow that involves invitations, if “Geoff” accepts the invitation from “Chris” and is a service user or becomes a service user, “Geoff” and “Chris” are associated and they are service user contacts on each other's service phonebook. If the mobile numbers of “Geoff” and “Chris” are already on each other's service contact list, then their service relationship can be immediately associated and established.

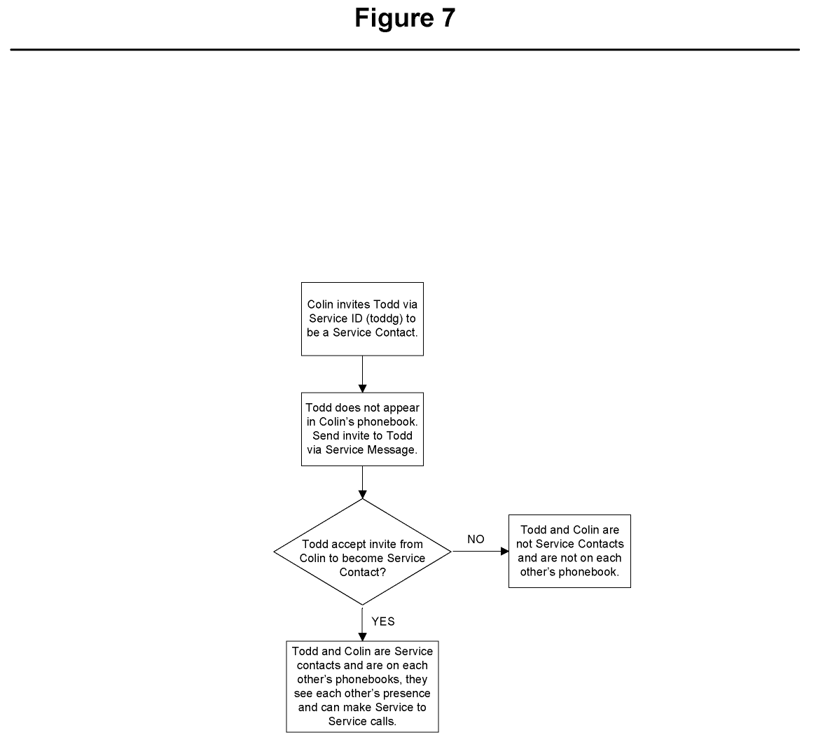

FIG. 7 is an embodiment of a sample use case flow of a service user “Colin” inviting another service user “Todd” via the service ID rather than by their respective mobile numbers. In this sample use case flow, once the invited party accepts the invitation, the two service users “Colin” and “Todd” are associated. A variant of this method applies to online dating where two anonymous parties can initiate contact through invitation request to establish permission to then initiate communications.

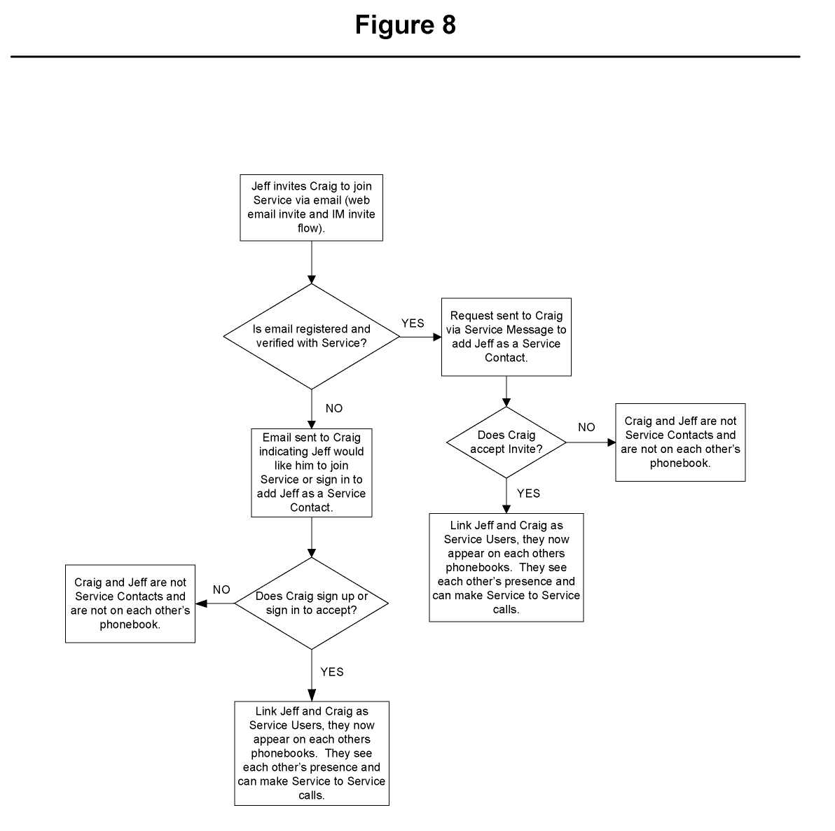

FIG. 8 is an embodiment of a sample use case flow of a service user “Jeff” inviting another Service user “Craig” via email address. This use case flow is conditional on a validated email address or one that is uniquely associated with a service user. Where there is a validated email or direct association between a service user and an email address, the invite message is converted to the service system message and delivered from the service inviter to the service invitee service message inbox. If the email address of the invitee party is not validated against an existing service user, the invitee may access an email link which requires signup or sign-on by the invitee. This signup or sign-on process may then associate the email address with the invitee service user. After the invitee successfully accepts the invitation, the inviter and invitee service users are associated and they become service user contacts on each other's service phonebook.

The service as disclosed may be implemented in certain embodiments according to the disclosure provided in U.S. patent application Ser. No. 11/314,971 titled “Distributed System For Clustering Communications Devices And Services Available To A User” and filed on Dec. 20, 2005, U.S. patent application Ser. No. 11/314,745 titled “Distributed System For Sharing Of Communication Service Resources Between Devices And Users” and filed on Dec. 20, 2005, U.S. patent application Ser. No. 11/428,283 titled “Dynamic And Context Driven Call Control And Service Bridging” and filed on Jun. 30, 2006, U.S. Provisional Patent Application No. 60/814,150, titled “Online Community And Identity Extension To Mobile Devices” filed on Jun. 16, 2006, all of which are hereby incorporated by reference in their entireties.

### CONCLUSION

The various features described above may be implemented in, and fully automated by code modules executed by general-purpose computing devices, including but not limited to one or more servers, PCs, Personal Digital Assistants, and mobile phones. The code modules may be stored in any type or types of computer storage device or memory. It should be understood that the various steps may alternatively be implemented in-whole or in-part within specially designed hardware.

The methods of the present disclosure may be implemented in whole or in part in the discussed application client, service gateway, and/or service core, in an embodiment. In other embodiments, the methods of the present disclosure may be implemented in separate modules or combined with other modules of various suitable communications services systems.

Although this invention has been described in terms of certain embodiments and applications, other embodiments and applications that are apparent to those of ordinary skill in the art, including embodiments which do not provide all of the features and advantages set forth herein, are also within the scope of this invention. Accordingly, the scope of the present invention is intended to be defined only by reference to the following claims.

What is claimed is:

1. A method of adding and associating users of a service based on user contact number, the method comprising:
accepting, via an application client, a set of contact information associated with an individual for storage in a user's service phonebook, the contact information including a name of the individual and a method of contacting the individual;
comparing the set of contact information associated with an individual with information related to a second service user;
when at least a portion of the set of contact information matches the information related to the second service user, sending a service association request to the second service user.

2. The method of claim 1 wherein the method of contacting the individual comprises a mobile phone number.

3. The method of claim 1 wherein the method of contacting the individual comprises an instant messaging service ID or email address.

4. The method of claim 2 further comprising the steps of:
accepting an affirmative service association response from the second service user; and
updating the service phonebook to indicate that a service association has been accepted between the user and the second service user.

5. The method of claim 2 further comprising the steps of:
if the contact information does not match the information related to the second service user, sending a service invitation from the service system core to the individual based on the method of contacting the individual.

6. The method of claim 2, wherein the method further comprises the step of storing the set of contact information in the user's service phonebook, where the service phonebook is maintained on the service system core and is accessible through the application client on a user mobile device.

7. The method of claim 2, wherein the step of accepting a set of contact information comprises reading a native address book stored on a device terminal.

8. The method of claim 7 wherein the device terminal comprises a mobile device.

9. The method of claim 2 wherein the step of accepting a set of contact information comprises importing information from a computer-based address book.

10. The method of claim 9 wherein the computer-based address book comprises an Outlook address book.

11. The method of claim 9 wherein the computer-based address book comprises a Yahoo! address book.

12. The method of claim 9 wherein the computer-based address book comprises an internet-based address book.

13. The method of claim 9 wherein the step of accepting a set of contact information is further accomplished through a network connection.

14. The method of claim 5, wherein the step of sending a service invitation is performed in response to an approval by the user.

15. The method of claim 5, wherein the step of accepting a set of contact information is initiated by selecting a non-user contact from the user's service phonebook.

16. The method of claim 5, wherein the step of accepting a set of contact information is initiated when the user initiates a call to the individual.

17. A computer storage device having stored thereon an executable code which embodies the method of claim 1.

18. A computer system programmed to perform the method of claim 1.

19. A computerized method of associating service users, the method comprising:
storing a first service phonebook associated with a first service user, the first service phonebook comprising a plurality of contact entries;
storing a second service phonebook associated with a second service user, the second service phonebook comprising a plurality of contact entries;
searching the first service phonebook's plurality of contact entries for a contact entry associated with the second service user;
when the first service phonebook includes the contact entry associated with the second service user, searching the second service phonebook's plurality of contact entries for a contact entry associated with the first service user; and
when the first service phonebook includes the contact entry associated with the second service user and the second service phonebook includes the contact entry associated with the first service user, updating the contact entry associated with the first service user to indicate a service association with the second service user.

20. The method of claim 19 further comprising the step of:
when the first service phonebook includes the contact entry associated with the second service user and the second service phonebook includes the contact entry associated with the first service user, updating the contact entry associated with the second service user to indicate a service association with the first service user.

21. The method of claim 19 wherein the indication of a service association with the first service user allows for added functionality of the second service phonebook.

22. The method of claim 21 wherein the added functionality includes an availability indicator.

23. The method of claim 21 wherein the added functionality is controlled at least in part by preferences of one or both of the first service user and second service user.

24. The method of claim 19 wherein the step of searching the first service phonebook's plurality of contact entries includes searching for a phone number of the second user.

25. A computer storage device having stored thereon an executable code which embodies the method of claim 19.

26. A computer system programmed to perform the method of claim 19.

27. A method of associating users of a communications service, the method comprising:
maintaining a service phonebook for a first service user in computer storage;
adding contact information associated with a second service user to the service phonebook;
using the contact information associated with the second service user and information associated with the first service user to generate an invitation to add the first service user to a service phonebook associated with the second service user; and
sending the invitation to a service device operated by the second service user.

28. The method of claim 27 further comprising the steps of:
receiving a response to the invitation from the second user; and
adding contact information associated with the first service user to the second service user's service phonebook.

29. The method of claim 27 wherein the service device operated by the second service user is a mobile phone.

30. A method of updating a phonebook for a communications service, the steps of the method comprising:
maintaining, in computer storage, a first service phonebook associated with a first service user, the first service phonebook including contact information associated with a second service user;
accepting an update to the contact information associated with the second service user from the second service user;
checking whether an association indication exists between the first service user and the second service user; and
when the association indication does exist between the first and second user, altering the first service phonebook with the update to the contact information.

31. The method of claim 30 further comprising the step of:
alerting the first service user to the update to the contact information associated with the second service user.

32. A computer storage device having stored thereon an executable code which embodies the method of claim 30.

33. A computer system programmed to perform the method of claim 30.
